(19) United States
(12) Patent Application Publication
(10) Pub. No.: US 2005/0071758 A1
(43) Pub. Date: Mar. 31, 2005

(54) Client-side processing of alternative component-level views

(75) Inventors: Nathanael F. Ehrich, Raleigh, NC (US); Niraj P. Joshi, Cary, NC (US); Kimberly D. Kenna, Cary, NC (US); Robert C. Leah, Cary, NC (US)

Correspondence Address: Gerald R. Woods;IBM Corporation T81/062, PO Box 12195, Research Triangle Park, NC, 27709, US

(73) Assignee: International Business Machines Corporation, Armonk, NY (US)

(21) Appl. No.: 10/675,418

(22) Filed: Sep. 30, 2003

(51) Int. Cl. G06F 17/00

(52) U.S. Cl. 715/513

(57) ABSTRACT

Techniques are disclosed for selecting alternative content views for rendering. Using these techniques, content designers specify alternative content views that are designed for use under different conditions, and a particular alternative view is programmatically selected (according to applicable conditions) when the content is to be rendered. Preferably, the alternative views are provided on a component-level basis, where the selected component view or version then forms part of a larger view (such as a Web page). Optionally, more than one component may be designed to vary simultaneously. In this case, the components may vary independently of one another.

### RELATED INVENTION

The present invention is related to commonly-assigned, co-pending U.S. patent application Ser. No. ______, titled “Providing Scalable, Alternative Component-Level Views”. The related application (referred to herein as “the related invention”) was filed concurrently herewith and is hereby incorporated herein by reference.

### BACKGROUND OF THE INVENTION

1. Field of the Invention

The present invention relates to client/server computing, and deals more particularly with techniques for dynamically selecting from among a plurality of scalable, alternative component-level views when rendering content at a content receiver (such as a client workstation).

2. Description of the Related Art

The popularity of client/server computing has increased tremendously in recent years, due in large part to growing business and consumer use of the public Internet and the subset thereof known as the “World Wide Web” (or simply “Web”). Other types of client/server computing environments, such as corporate intranets and extranets, are also increasingly popular. As solutions providers focus on delivering improved Web-based computing, many of the solutions which are developed are adaptable to other client/server computing environments. Thus, references herein to the Internet and Web are for purposes of illustration and not of limitation. (Furthermore, the terms “Internet”, “Web”, and “World Wide Web” are used interchangeably herein.)

Millions of people use the Internet on a daily basis, whether for their personal enjoyment or for business purposes or both. As consumers of electronic information and business services, people now have easy access to sources on a global level. When a human user is the content requester, delays or inefficiencies in returning responses may have a very negative impact on user satisfaction, even causing the users to switch to alternative sources. Delivering requested content quickly and efficiently is therefore critical to user satisfaction. Furthermore, if the content contains advertising or similar promotional information, delivering content to end users in a timely manner may be required to meet contractual obligations with, and/or to ensure repeated business with, the advertisers and promoters.

Most modern computing applications render their displayable output using a graphical user interface, or “GUI”. In a client/server computing environment such as the Internet, client software known as a “browser” is typically responsible for requesting content from a server application and for rendering the information sent by the server in response. Commonly, the displayed information is formatted as a Web page, where the layout of the Web page is defined using a markup language such as Hypertext Markup Language (“HTML”).

Designing a Web site to serve the needs of a varied audience is a complex undertaking. A Web page providing stock quotes, for example, may be of interest to end users whose computing devices range from cellular phones and other handheld devices with limited display space to powerful desktop workstations with a relatively large amount of display space. A Web page designer may choose to focus the page layout toward the capabilities of the higher-end computing devices, in order to improve the viewing experience of that subset of the potential users. This may result in a Web page that is difficult or impossible to use from a lower-end or constrained device.

Similarly, designing a Web site that operates well under varied network conditions may be challenging. Web pages containing rich multimedia content, for example, may provide an enjoyable viewing experience for users of full-function computing devices when those pages are displayed in a full-screen browser window. On the other hand, if users of limited-function devices that have small displays access these same pages, or if the page display on a large GUI is resized to be relatively small, then the useful information content of the Web page may be lost, or the viewing experience may become unpleasant for the user, and so forth.

Techniques are known in the art that consider factors such as current network conditions, capabilities of the client device, and preferences of the end user when preparing content to be delivered from a server. Commonly-assigned U.S. Pat. No. 6,138,156, titled “Selecting and Applying Content-Reducing Filters Based on Dynamic Environmental Factors”, discloses techniques with which environmental factors can be used to dynamically filter the content being delivered from a server to a user's workstation. The environmental factors include characteristics of the target device, such as its available storage capacity, and billing information related to the user's account with his connection service provider. These factors are used with a rule-based approach to select a transcoding filter to be applied to a document before delivering it to a requesting user. If the end user's device has limited available storage, for example, then a color image to be rendered on a Web page might be transcoded to gray-scale, or even completely omitted, before sending content to this device.

Commonly-assigned U.S. Pat. No. ______ (Ser. No. 09/504,209, filed Feb. 15, 2000), which is titled “Aggregating Constraints and/or Preferences Using an Inference Engine and Enhanced Scripting Language”, teaches techniques for aggregating constraints and/or preferences using an inference engine and an enhanced scripting language. Values of multiple factors and the interrelationships between the factors and their values are aggregated, and the result is used to tailor or direct the processing of a software program. A rule-based system is disclosed therein for aggregating information, and based on the aggregated result, one or more transformations are performed on a requested document before transmitting it to the requester. The particular transformations to be performed may be tailored to constraints such as one or more of: the capabilities of the client device; the connection type over which the content will be delivered; the network bandwidth of the connection; the type of user agent operating on the client device; preferences of a particular user; preferences set by a systems administrator or other such person (or preferences generated in an automated manner); preferences for a particular application executing in a particular domain; etc. According to preferred embodiments of this commonly-assigned invention, the aggregated result is made available to an application program, which will use the result to tailor its own processing. This technique avoids having to change the software process itself as new values and/or new factors are deemed to be important to the aggregation result.

Commonly-assigned U.S. Pat. No. ______ (Ser. No. 09/442,015, filed Nov. 17, 1999), which is titled “Context-Sensitive Data Delivery Using Active Filtering”, discloses techniques for providing context-sensitive data delivery using active filtering to tailor the delivered data content. Preferably, a server maintains information about the typical device types to which it serves data, and continually pre-filters available data for delivery to these devices. Style sheets are used to perform one or more device-specific filtering transformations. In delivering content to a particular device, the server receives a device certificate from the device, and uses this information to identify the device type and the device's user. A user's stored preferences and/or access privileges can then be determined, and this information can be used to refine or filter information available from the server. In particular, this invention discloses filtering information to account for one or more of: an identification of a user of the device; privileges (also referred to conversely as limitations) and/or preferences of the user; the location, device type, and/or device capabilities of the user's device; and the current time.

In another prior art approach, Web sites may implement a choice of two content views, one providing high graphic content and the other providing low graphic content, thereby providing alternative views. Sometimes, the end user is given the choice of which view he wants to see (e.g., by having a graphical button on the Web page that can be clicked to select one content type or the other). Or, using a prior art “<IMG>” (image) tag in a Web page, the content designer can specify that the type of content (either an image file or a substituted text message) to be delivered to the client can be selected using factors such as device type or server load. However, this approach generally provides a binary decision, whereby a selection is limited to two choices.

Except where the GUI provides a graphical button that allows the end user to select between content types, all of these prior art techniques make the decision about what content will be rendered on the client ahead of time, on the server side, when the server is preparing content for delivery to the client. This decision is then reflected in the content delivered to the client (typically in a markup language document such as a Web page encoded in HTML, as noted earlier).

Accordingly, what is needed are techniques for selecting alternative content views for rendering.

### SUMMARY OF THE INVENTION

An object of the present invention is to provide techniques for improved handling of alternative content selection.

Another object of the present invention is to provide techniques that enable content designers to specify alternative content views that are designed for rendering under different client-side conditions.

Still another object of the present invention is to provide techniques for programmatically selecting a particular alternative view of component-level content when rendering content at a client.

Yet another object of the present invention is to provide techniques whereby a content designer specifies two or more alternative content, or component-level, views along with conditions under which a particular alternative view should be selected when rendering content at a content receiver.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products. In one aspect, techniques are provided for dynamically selecting from among a plurality of alternative component-level views when rendering content at a content receiver. This aspect preferably comprises: evaluating one or more factors to yield an evaluation result; and using the evaluation result to select, from among a plurality of alternative selectable views of a particular component, a view to be rendered. This aspect may further comprise rendering the selected view.

The view to be rendered may comprise a portion of content to be rendered, and may be a portion of a Web page to be rendered. The alternative selectable views may be specified in a markup language document (such as a Web page that is to be rendered), and/or they may be specified using a scripting language syntax. The logic (or a reference thereto) to be used in the evaluation may be specified therein. Optionally, more than one dynamically variable component may be specified, in which case alternative selectable views are specified for each such component.

In another aspect, the present invention provides techniques for generating content containing alternative component-level views to be rendered at a content receiver. This aspect preferably comprises programmatically generating a syntax specification which includes a plurality of alternative selectable views for at least one component, such that a run time evaluation of the syntax specification will evaluate one or more currently-applicable conditions and use a result of the evaluation to programmatically select a particular one of the alternative selectable views for each of the at least one components. The programmatic generation may further comprise selecting the plurality of alternative selectable views for at least one of the components based on one or more characteristics of a target receiver of the syntax specification. The syntax specification may be generated as a portion of a markup language document.

The present invention will now be described with reference to the following drawings, in which like reference numbers denote the same element throughout.

### BRIEF DESCRIPTION OF THE DRAWINGS

FIG. 1 provides a sample HTML document showing representative syntax with which alternative, selectable component-level views may be specified in a document that is to be rendered, according to the present invention;

FIGS. 2A and 2B show samples of how selected components may be rendered to provide scalable, component-level views, according to the present invention; and

FIG. 3 provides a flowchart depicting logic that may be used to implement preferred embodiments of the present invention.

### DESCRIPTION OF PREFERRED EMBODIMENTS

The present invention provides novel techniques for specifying alternative content for selectable rendering, according to currently-applicable values of one or more factors, and for dynamically selecting from among the alternatives. Using these techniques, content designers specify alternative content views that are designed for use under different conditions, and a particular alternative view is programmatically selected (according to applicable conditions) when the content is rendered. (Preferred embodiments are described with reference to rendering content at a “client workstation” or a “requesting client workstation”, although this is by way of illustration and not of limitation.)

According to preferred embodiments of the present invention, a content designer identifies, at design time, multiple versions (also referred to as multiple views) of a component that will form part of a rendered Web page. The content of the Web page will then vary dynamically at run time, depending on which version of the component is selected for rendering. Preferred embodiments of the present invention use a markup-language notation or scripting-language notation for specifying, within the framework of a Web page which is to be rendered, the syntax defining selectable alternative views. The term “ALTlet” is used herein to refer to the syntax with which a particular component's alternative views are specified.

Optionally, an implementation of the present invention may allow more than one component of a particular Web page to vary simultaneously, and therefore references to varying “a” component, or one component, are illustrative but not limiting. Preferred embodiments specify a separate ALTlet (i.e., separate ALTlet syntax) for each such component. When multiple ALTlets are specified in a single Web page, a particular view for each dynamically-variable component can then be selected independently when rendering a view of this single Web page. Alternatively, it may be desirable in some cases for the particular view that is selected for one dynamically-variable component to dictate which view is selected for one or more other dynamically-variable components within the same Web page. Examples will be described herein.

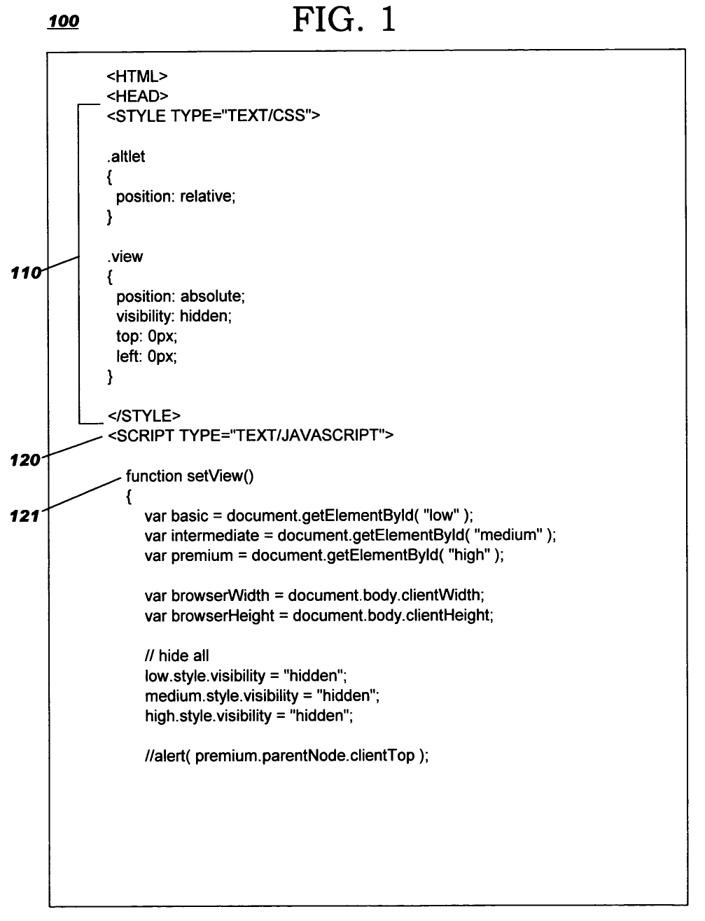

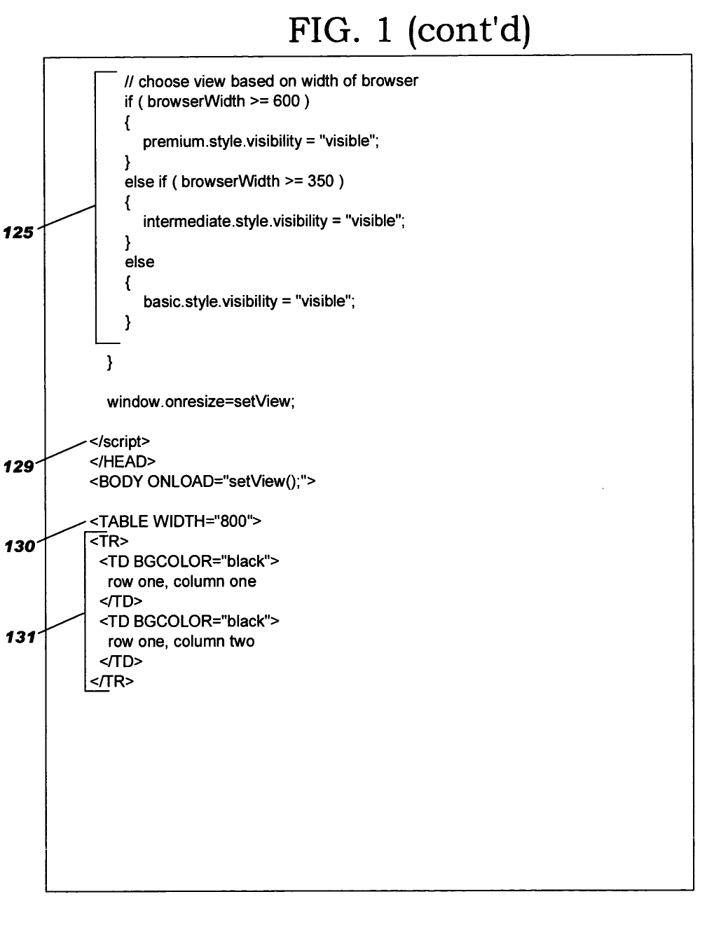

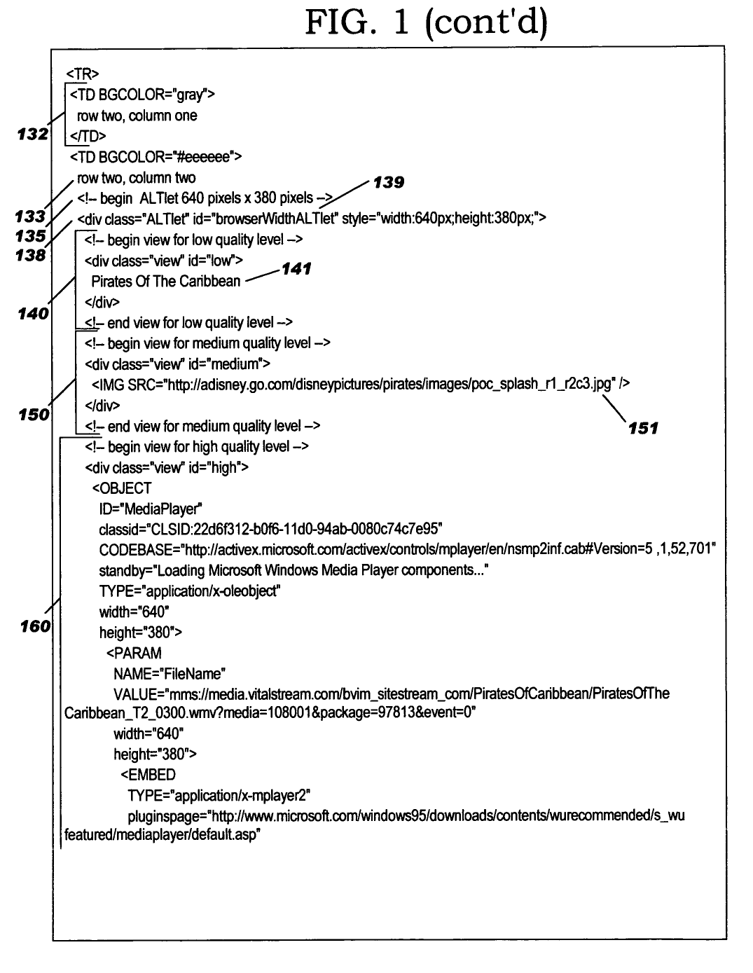

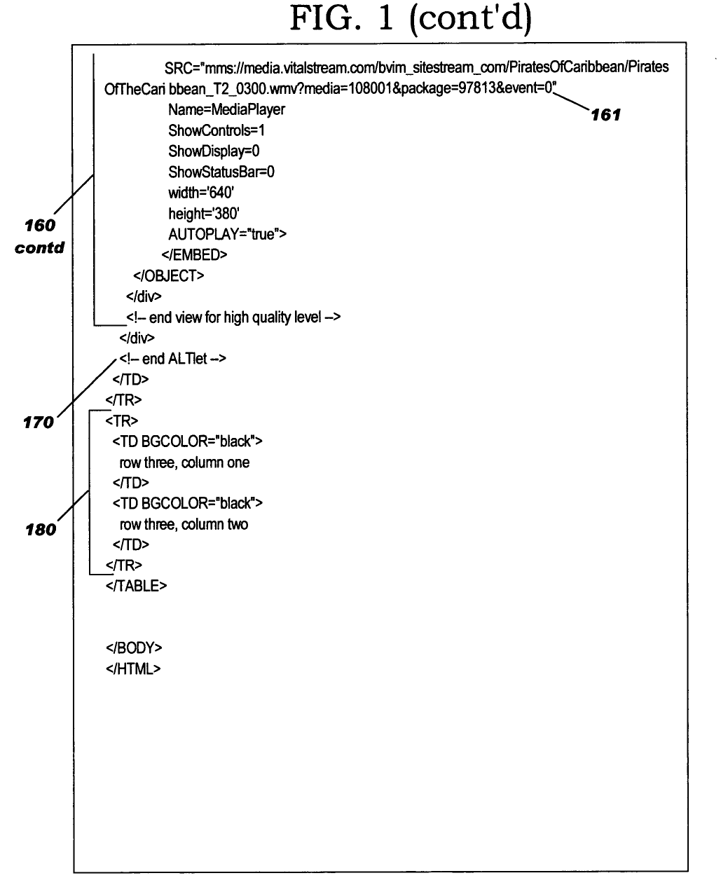

FIG. 1 illustrates syntax specifying a single client-side ALTlet. This figure is discussed in more detail below. (The term “ALTlet”, as used hereinafter, refers to client-side ALTlets unless stated otherwise. Note that client-side ALTlets of the present invention are different from server-side ALTlets of the related invention.)

Preferred embodiments of the present invention operate at a client, responsive to receiving content requested from a content source such as a Web server. When received, the content (which is described herein as a Web page, for purposes of illustration) preferably includes an identifier of each of the various selectable views, as well as an identification of conditions under which each of the views should be selected for rendering. Applicable factors or conditions are preferably evaluated by the client when the Web page is to be rendered. Factors considered by preferred embodiments may include (by way of illustration) one or more of the following types of stimuli: (1) current size of a GUI window in which the content will be rendered and/or the available real estate within a GUI window in which this particular component will be rendered; (2) current processing load on the rendering device; (3) currently-executing applications on the rendering device; and (4) open network connections at the rendering device. Optionally, an implementation of the present invention may use other types of system/network factors such as processor capacity at a remote content source or current network load, which may (for example) affect the client's ability to retrieve content referenced from a dynamically-variable component in a timely manner. (The manner in which values of system/network factors are created does not form part of the present invention. An implementation of the present invention may invoke an application programming interface, or “API”, to retrieve such values.)

The related invention defines server-side processing techniques, whereby one or more components (which are specified in server-side ALTlets of a source document such as a Web page template) are programmatically selected at the server for delivery to a requesting client, according to preferred embodiments, based on run-time factors such as: (1) device type used by the requester; (2) bandwidth limitations, if any; (3) subscription level of the requester; and (4) other types of system/network factors such as processor capacity or current network load. For example, if a company markets a Web page service for delivery of current traffic conditions that uses a variable-level subscription business model (e.g., whereby several different levels of content are available at varying subscription rates), the server-side techniques of the related invention enable delivering a view of traffic ranging from a simple text description to live video feed, based on the subscription level. Refer to the related invention for more information on these server-side techniques. Using server-side ALTlets, as described therein, allows a Web page designer to specify which alternative component-level view(s) should be used when the server creates a Web page for delivery to a requester.

Returning to discussion of the client-side techniques of the present invention, suppose, as an example, that the end user resizes a window in which a Web page is displayed. The present invention enables components comprising the Web page to be dynamically selected for rendering in the resized window.

As one example of this dynamic selection, suppose that the Web page delivered in the hypothetical traffic report service is to be surrounded by a collection of advertisements. In the prior art, if a Web page containing advertisements is made smaller than the size for which the page layout was designed, advertisements are often either partially or completely truncated. If advertisers are paying fees to the content provider for displaying their ads to end users, this truncation may result in payments being made when the advertisements are not actually viewable by the client (which is an undesirable situation for the advertisers and, therefore, for the traffic report service provider as well).

Use of the present invention, in contrast, enables programmatic run-time decisions to be made, based on information specified by the Web page designer for inclusion in a client-side ALTlet, about how various components of the Web page should be rendered when the Web page size is changed. It may be desirable, for example, to dynamically retrieve smaller versions of each advertisement from a back-end server and to display these smaller versions, rather than truncating (or omitting) larger versions of the advertisements. Or, the Web page designer might specify syntax that programmatically omits selected ones of the advertisements (or a selected number or selected percentage thereof) that would have been displayed if the content was rendered in a larger window. In this manner, the Web page designer can ensure that at least some portion of the advertising will remain visible even though the page is rendered in a size that does not permit the “preferred” advertising layout to be rendered. Selection of alternative views in this manner may be triggered, for example, by the Web page being rendered in a particular size or at a relative percentage of a particular size.

Techniques are known in the art whereby static conditions pertaining to a client workstation may be used to tailor content that is delivered to that client. For example, as discussed above with reference to commonly-assigned U.S. Pat. No. 6,138,156, a server (or an intermediate in the network path, alternatively) may remove images before sending content to a resource-constrained device. Preferred embodiments of the present invention, by contrast, respond to dynamic conditions and perform the selection among alternative views at the client.

As another example of the dynamic view selection provided by the present invention, suppose that the information content in a Web page (which in this example does not include advertising) is adversely affected by shrinking the display to a smaller size (e.g., when the end user selects the frame of the displayed window and drags the frame, thereby reducing the window size). Techniques disclosed herein may be used by Web page designers to enable client-side processing to dynamically respond to this window size reduction, whereby content-specific decisions are encoded in the client-side ALTlet to render (for example) an alternative version of the content, or a different media form of the content, and so forth. (See the discussion of FIG. 1, below, for an example.)

Note that these client-side ALTlets enable the company's information technology (“IT”) professionals (including the Web page designer) to specify multiple views for a Web page component within a single Web page. The views that are not applicable and are therefore not selected, according to the factors or conditions which are evaluated, remain in the Web page syntax (where they may potentially be selected for rendering if values of the evaluated factors/conditions change).

Additional examples of the type of factors that may be considered by the client-side selection logic were noted above. For example, if a client device is currently executing more than some threshold number of applications, or is executing one or more applications that are identified in a configuration file (where those applications might be compute-intensive or where priority handling might be desired for their GUI displays), then client-side ALTlets may specify that one or more components of a Web page to be rendered may be dynamically adjusted (i.e., by selecting among alternative views) in response to those factors. Or, in a Web page that requires retrieval of rich multi-media content from a back-end server during rendering (and which will therefore consume large amounts of bandwidth), an ALTlet might specify that a less-rich view of the content is to be retrieved if the network is currently congested.

Continuing with the window resizing example, suppose the Web page designer wishes to provide three different alternative views of a component within a Web page, where this component pertains to a movie promotion, and that the run-time decision of which view should be rendered is to be based on the current width of the client browser window. This scenario is illustrated by the ALTlet in FIG. 1, which is specified within an HTML Web page 100. In addition, this Web page 100 includes a specification of a style sheet (see reference number 110), and script statements encoded in the JavaScript® scripting language are used for specifying this ALTlet. (“JavaScript” is a registered trademark of Sun Microsystems, Inc.) See reference number 120, where this intelligent client-side script specification begins, though reference number 129, where it ends.

As shown generally at reference number 125 of FIG. 1, a premium version of the content is to be rendered when the window size is at least 600 pixels wide, whereas an intermediate version is to be rendered if the window is at least 350 pixels but less than 600 pixels wide, and a basic version of the content is to be rendered if the browser window is less than 350 pixels wide. In this example, the basic content (also referred to in FIG. 1 as the “low quality” level) is rendered as a textual representation of the movie title. See reference number 140, and more particularly, reference number 141, where the value of the “div” element provides the movie title. The intermediate content (also referred to in FIG. 1 as the “medium quality” level) is rendered as a still image (i.e., from a “.jpg” file) of the movie. See reference number 150. At reference number 151 therein, a Uniform Resource Locator (“URL”) is specified, from which the image may be retrieved over a network. Reference number 160 specifies how the premium content (also referred to in FIG. 1 as the “high quality” level) is to be rendered. In this case, a full-motion multi-media version (i.e., from a “.wmv” file) is identified by the URL at reference number 161.

Although three alternative view specifications are presented in this example, an implementation of the present invention may choose to support any number of alternative views, thereby allowing for a wide away of alternative content to be selected for rendering a view of a particular component.

For purposes of illustration, the ALTlet in this example is displayed within a table cell. See reference number 130, where the HTML table definition begins. The table is 800 pixels wide, and is defined as having two columns and three rows. The first row is designed as a top border which comprises two black graphical bars (one for each column). See reference number 131. (While textual content is specified for each of the columns or cells of this first row, the text is not generally visible because the cell background is defined as black, thereby obscuring the text.) The second table row has a gray bar in the leftmost cell, and the text “row two, column one” is to be rendered in that cell. See reference number 132. The rightmost cell of the second row is where the dynamically-variable movie promotional content, or component-level view, will be rendered in this example. The text “row two, column two” is to be rendered at the top of this cell. See reference number 133. The variable content, specified as an ALTlet using syntax that begins at reference number 135 and continues through reference number 170, will be rendered in this same cell, beneath the text that is specified at reference number 133. The third and final row of the table layout is similar to the first row, providing a bottom border which comprises a black graphical bar for each column. See reference number 180. (Again, the textual content specified for each of the cells of this third row is not generally visible because the text is obscured by the black cell background.)

The variable content syntax specification was briefly described above, with reference to the three different types of content that may be selected for rendering in this example. This syntax specification will now be described in more detail. Reference number 138 specifies a parent “div” element which has three child elements (each specifying one of the three alternative views). This parent element has a “class” attribute, an “id” attribute, and a “style” attribute. The value of the “class” attribute specifies that this is an ALTlet. The “id” attribute is preferably used to associate an identifier (“browserWidthALTlet”, in this case) with the ALTlet specification 138. This facilitates identification of each ALTlet when more than one ALTlet is included in a particular Web page or markup language document. The optional “style” attributes specifies the GUI real estate allocated for rendering the selectable views defined in the ALTlet.

Note that in some cases, it may be desirable to allow a varying style, such as a varying width and/or height, for the selectable views of an ALTlet. An implementation of the present invention may therefore support specification of “style” attributes on the tags for the selectable views, where those values preferably override a “style” attribute value that may be specified on the parent tag. Or, additional or different attributes may be used to allow ALTlets to vary properties of their allocated GUI real estate.

Reference number 140 provides a child “div” element having a “class” attribute and an “id” attribute. The “class” attribute specifies that this is a view, and the “id” attribute specifies that this view is associated with the “low” quality level. Similarly, the “id” attribute for the “div” element at reference number 150 specifies that this view is associated with the “medium” quality level, and the “id” attribute for the “div” element at reference number 160 specifies that this view is associated with the “high” quality level. As can be seen by inspection of the value of each of the three child “div” elements, different information (which in this case is increasingly detailed) is specified for each of the three alternative media types The specification of the multi-media content type in the “div” element at reference number 160, for example, provides for dynamically downloading a media viewer.

It can be seen from the example in FIG. 1 that the present invention provides easy-to-use yet powerful techniques with which a plurality of dynamically-selectable component-level views (as well as logic that enables this dynamic selection) can be specified within a single Web page. By opening a Web browser window and loading this sample HTML Web page 100 into the window, this dynamic view selection can be experienced. If the Web browser window is at least 600 pixels wide when the page is initially rendered, for example, then the full-motion video (from the URL at reference number 160) will play in row 2, cell 2 of the displayed table format. If one of the sides of the window is dragged (or the window is otherwise reduced in width) while the video is playing, the video will continue to be shown as long as the window width is still at least 600 pixels. However, as soon as the window width is less than 600 pixels, the video will be programmatically (and immediately) replaced with the still image that is defined (at reference number 150) for the intermediate or medium-quality view. Similarly, if the window size is further reduced such that it becomes less than 350 pixels wide, then the still image will be programmatically (and immediately) replaced with the textual movie name (as defined at reference number 140).

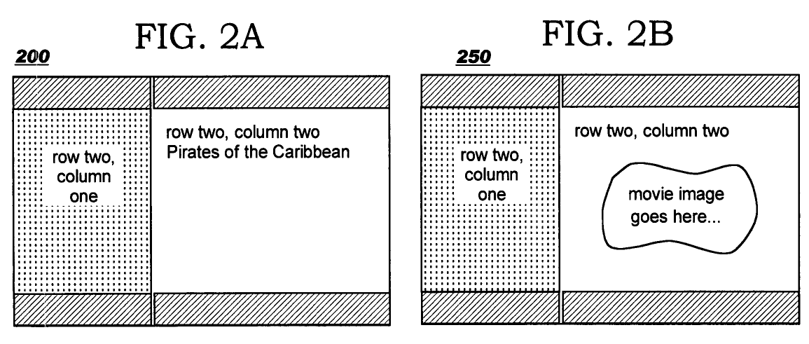

FIG. 2A illustrates a rendered “low-quality” view 200, wherein the movie title is displayed in row 2, column 2 of the table, and FIG. 2B illustrates a rendered “medium-quality” view 250 wherein an image for the movie promotion is displayed in that location instead of the movie title. The examples provided in FIGS. 2A and 2B use hashing as substitutes for the black and gray shading that appears in an actual rendering. (In FIG. 2B, the image has been depicted only in outline form, for ease of illustration. An actual JPEG image often contains many colors and typically has fine-grained detail when rendered, as is known in the art.) The video to be rendered in the “high-quality” view has not been depicted.

Using techniques of the present invention, the company's IT professionals can design a Web page where one or more components of the content will vary dynamically when rendered, even though multiple versions of that Web page do not need to be manually created. Instead, according to preferred embodiments, the Web page is created to include syntax that specifies the selectable versions of components that may be rendered within that Web page, as noted above. Along with each selectable version of a component, syntax is specified that enables a programmatic selection to be made, such that the desired selectable version can then be “plugged in” at run time, when the Web page is rendered.

Instead of using the client-side ALTlet syntax as illustrated in FIG. 1, an implementation of the present invention may use an alternative syntax without deviating from the concepts disclosed herein. For example, a different markup language may be used instead of HTML, such as the Wireless Markup Language (“WML”), Extensible Hypertext Markup Language (“XHTML”), and so forth.

Note that if an implementation of the present invention is used in combination with an implementation of the related invention, then the client-side ALTlet syntax may be selected by the server, from among other dynamically-selectable component versions specified in a server-side ALTlet, for inclusion in a Web page that is to be delivered to a client. Or, the client-side ALTlet may be delivered to all clients while the selectable processing at the server side comprises dynamically selecting a view (from a server-side ALTlet) for one or more other components of the Web page. (Refer to the related invention for more details on how servers select among different component versions or views.)

Several prior art approaches to rendering Web page content will now be described, in order to contrast prior art approaches with the novel techniques disclosed herein.

In the prior art, the “<IMG>” (image) tag currently supported in HTML provides for a very limited specification of alternative content that may vary dynamically when rendered at a client. Using this existing tag, a “src” (source) attribute specifies an address of an image to be rendered in a Web page, and an optional “alt” (alternative) attribute can be used to specify textual content that may be rendered in place of the image. The client-side decision of which content to render in a particular situation may depend on processing constraints, user preferences, and so forth. A maximum of two alternatives for the rendered content are possible, and the content types are limited to images and text, when using the existing <IMG> tag. As can be seen from the example presented in FIG. 1, use of the present invention enables Web page designers to go well beyond the binary choices available using this prior art <IMG> tag, such that widely-varying viewing experiences can be provided for end users.

Portal servers of the prior art may provide for varying display content based on whether a portlet is displayed in its maximized form or in a minimized form. However, this is a static, binary client-side decision, providing only one or the other of two views. This prior art technique also differs from the techniques disclosed herein whereby a client-side selection is made from among a variable number of views for each of one or more individual components (and where this selection may be made using many factors other than whether the page is currently minimized).

In general, techniques of the present invention may be used to vary the richness of content among a variable number “N” of component-level views. Scalable content can then be rendered at a client by selecting from among these N views for that component. This variation among views may optionally be extended to “M” different components within a particular Web page (as has been noted above), and therefore a single Web page created using client-side ALTlets as disclosed herein is capable of representing M*N different potential viewing experiences for the end user.

Alternative component-level views of the type illustrated by the examples described thus far may be appropriate in many scenarios other than run-time window resizing. In addition, an interplay of multiple factors may be used when selecting among available views for a component. A parent document (such as an HTML Web page) specifies the selectable views or versions, and a selection is made programmatically when rendering the document, as has been illustrated.

Although not illustrated in the example, an implementation of the present invention may optionally allow different ones of the choices of component-level views for a particular component to be allocated different amounts of display space on the client's GUI. This, in turn, may cause other components of the displayed page to be displayed differently. An implementation of the present invention that supports this optional processing can perform additional dynamic tailoring of a Web page for the target client (even though, as has been stated, only one Web page template needs to be defined).

Furthermore, an implementation of the present invention may optionally support more than one client-side ALTlet within a particular Web page. In this case, each ALTlet may have its own unique evaluation logic. Or, it may happen that more than one ALTlet uses the same evaluation logic. In addition, evaluation logic for one ALTlet may, in some cases, simply select among several outcomes based on the result of another evaluation routine. As an example, if one evaluation routine determines that the GUI real estate allocated to a particular component view should be increased by some amount, another evaluation routine may be adapted for reducing the GUI real estate allocated to another component view by that same amount.

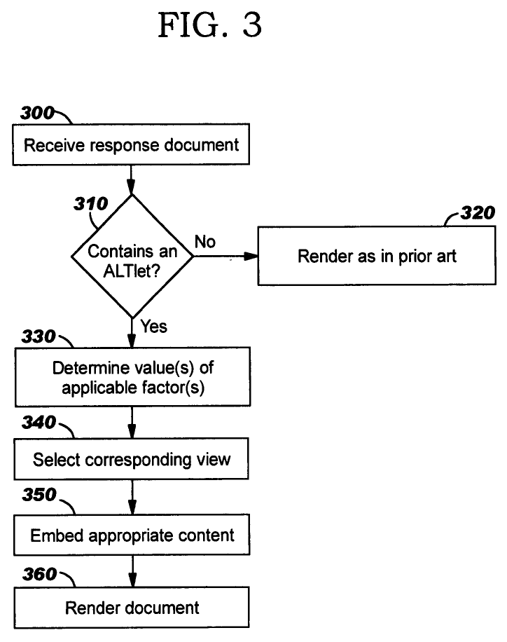

Referring now to FIG. 3, a flowchart is provided depicting logic that may be used to implement preferred embodiments of the present invention. As shown therein, a response document is received (Block 300) by client-side logic, which then proceeds to render this response. This comprises first testing (Block 310) to see if this request includes an “ALTlet”, i.e., whether this response document includes markup language tags specifying a selection among component views, as has been described above. If not, then normal processing of the prior art is performed (Block 320).

Otherwise, when the test at Block 310 has a positive result, then the values of the applicable factors are determined (Block 330). In one approach, the Web page includes its own factor-evaluating logic for determining an evaluation result, where this logic is preferably expressed in a client-side scripting language such as JavaScript. See FIG. 1 (and more particularly, the function which begins at reference number 121), where this approach has been illustrated. Upon determining the evaluation result, a programmatic selection of the corresponding view from the Web page (i.e., from the ALTlet specified therein) is made (Block 340). Thus in the browser width scenario, the evaluation routine which begins at reference number 121 (and in particular, the conditional logic at reference number 125) determines which of the selectable views 140, 150, 160 is appropriate for rendering.

In another approach, the applicable factors that should be evaluated may be determined from the value of the “type” attribute on the ALTlet tag. See reference number 139 in FIG. 1, for example, where this attribute has the value “browserWidthALTlet”. When using this approach, the attribute value preferably identifies an evaluation routine (for use in Block 330) that is adapted for dynamically locating values of certain factors or stimuli and determining an evaluation result therefrom. For example, in the scenario of using current network congestion information to determine which view of a remotely-stored image to request, an “id” attribute for the ALTlet might specify a value of “getNetworkTraffic”, where this value may identify a locally-accessible routine that determines the current network congestion. The result of an invocation of such code may then be used to access a repository that maps return values from that code to values of the “id” attributes specified on the <view> tags for the ALTlet's selectable views (or in some cases, the return values may be designed to map directly to the “id” attribute values of those selectable views).

Block 350 then embeds content into the Web page, if required (for example, by retrieving content of the image specified at 151 or of the video specified at 161). Any additional ALTlets are preferably processed in an analogous manner (although this iteration has not been illustrated in FIG. 3). Once all ALTlets have been evaluated, the resulting Web page is then rendered (Block 360) by the client.

As has been demonstrated, the present invention provides advantageous techniques for selecting among varying component-level views for rendering content. Typically, this occurs responsive to receiving a response message following a client request. Note, however, that it is not strictly necessary that this result is received responsive to a “request”. Alternatively, component-level views can be tailored and distributed using a “push” model, for example by identifying one or more clients who have subscribed for content updates, and then sending Web pages or similar documents to those clients wherein client-side ALTlets are specified with multiple component-level views that are dynamically selectable at the client, based on stimuli/conditions of the type described above.

Techniques disclosed herein may be leveraged to autonomically tune performance of a system/network. When a network is congested, for example, this factor can be used by factor-evaluating logic to dynamically select a less-rich and therefore smaller version of a component when requesting a view for that component from a remote content source for rendering, enabling a response message containing that component view to be transmitted across the network with a lessened impact (as compared to transmitting a larger version) on the existing congestion problem. Or, the evaluation logic might be adapted for checking the current hit rate at one or more Web servers. This information might then be used when determining which alternative view(s) to select when content for that view may need to be requested from a remote content source. For example, if a particular Web server is heavily loaded, then evaluation logic might be adapted for selecting a component view designed to minimize additional processing burdens at the back end.

While preferred embodiments were described with reference to rendering content that has been received, other aspects of the present invention comprise generating the Web page or similar document that contains client-side ALTlet syntax of the type described herein. This generation aspect may comprise creating identical ALTlet syntax for distribution to all clients, whereby run-time factors applicable at a particular client then select among the specified alternative component-level views. Or, the generation may comprise tailoring the ALTlet syntax for distribution to particular clients. For example, in the browser width scenario discussed above, the ALTlet might be generated to use different media types for the specified alternatives, where these choices of alternative media types are selected on the server side based upon characteristics such as the target client device or user agent, an identification of the end user (or stored preferences/privileges associated with that user), and so forth. In this latter approach to generation, the dynamically-selectable rendering at the client thereby effectively provides a second layer of selectability among views. Optionally, when an implementation of the present invention is used in combination with an implementation of the related invention, server-side ALTlets may specify how the client-side ALTlet syntax is to be tailored prior to distribution to a client. For example, the alternative views that are to be specified in a client-side ALTlet may be selected at the server from a server-side ALTlet, based on currently-applicable factors such as processing load on remote content servers (which will potentially receive requests for images and similar content during the client rendering operation), network congestion, and so forth.

Furthermore, techniques of the present invention are not limited to use with selectable views of the types explicitly described herein. These techniques are adaptable for use with generally any type of content, examples of which include (by way of illustration but not of limitation) animations, graphics (including scalable vector graphics, or “SVG”, images), and so forth.

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-readable storage media (including, but not limited to, disk storage, CD-ROM, optical storage, and so forth) having computer-readable program code embodied therein.

The present invention has been described with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor, or other programmable data processing apparatus to produce a machine, such that the instructions (which execute via the processor of the computer or other programmable data processing apparatus) create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart and/or block diagram block or blocks.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

1. A method of selecting among component-level views for rendering, comprising steps of:
evaluating one or more factors to yield an evaluation result; and
using the evaluation result to select, from among a plurality of alternative selectable views of a particular component, a view to be rendered.

2. The method according to claim 1, further comprising the step of rendering the selected view.

3. The method according to claim 1, wherein the view to be rendered comprises a portion of content to be rendered.

4. The method according to claim 1, wherein the view to be rendered comprises a portion of a Web page to be rendered.

5. The method according to claim 1, wherein the plurality of alternative selectable views are specified in a markup language document.

6. The method according to claim 5, wherein the markup language document comprises a Web page that is to be rendered.

7. The method according to claim 1, wherein the plurality of alternative selectable views are specified using a scripting language syntax.

8. The method according to claim 5, wherein a markup language element in the markup language document specifies the plurality of alternative selectable views, and wherein each of the alternative selectable views is specified as a child element of the markup language element.

9. The method according to claim 5, wherein the markup language document further specifies logic for use by the evaluating step.

10. The method according to claim 7, wherein the scripting language syntax further specifies logic for use by the evaluating step.

11. The method according to claim 5, further comprising the step of receiving the markup language document, at a client, from a server.

12. The method according to claim 11, wherein the evaluating and using steps are performed at, or on behalf of, the client.

13. The method according to claim 11, wherein the evaluating step evaluates at least one dynamic factor pertaining to the client.

14. The method according to claim 11, wherein the evaluating step evaluates at least one dynamic factor pertaining to a network to which the client is operably connected.

15. The method according to claim 4, wherein the Web page further comprises a plurality of alternative selectable views for each of one or more other components.

16. The method according to claim 15, wherein the using step is performed for each of the one or more other components.

17. The method according to claim 15, wherein the evaluating and using steps are performed for each of the one or more other components.

18. The method according to claim 16, wherein the view selected for one or more of the components comprising the Web page dictates the view selected for one or more of the other components comprising the Web page.

19. The method according to claim 16, wherein the view selected for each of the components comprising the Web page is selected independently.

20. The method according to claim 5, wherein the markup language document includes a reference to logic that performs the evaluating step.

21. The method according to claim 7, wherein the scripting language syntax includes a reference to logic that performs the evaluating step.

22. A method of enabling selectable content rendering, further comprising a step of:
programmatically generating a syntax specification which includes a plurality of alternative selectable views for at least one component, such that a run time evaluation of the syntax specification will evaluate one or more currently-applicable conditions and use a result of the evaluation to programmatically select a particular one of the alternative selectable views for each of the at least one components.

23. The method according to claim 22, wherein the programmatically generating step further comprises the step of selecting the plurality of alternative selectable views for at least one of the components based on one or more characteristics of a target receiver of the syntax specification.

24. The method according to claim 22, wherein the programmatically generating step further comprises the step of generating the syntax specification as a portion of a markup language document.

25. The method according to claim 22, wherein the programmatically generating step further comprises the step of selecting the plurality of alternative selectable views for at least one of the components based on one or more characteristics of a system in which a target receiver of the syntax specification is executing.

26. A system selecting among component-level views for rendering, comprising:
means for evaluating one or more factors to yield an evaluation result;
means for using the evaluation result to select, from among a plurality of alternative selectable views of a particular component, a view to be rendered; and
means for rendering the selected view as a portion of a Web page.

27. A computer program product for enabling selectable content rendering, the computer program product embodied on one or more computer-readable media and further comprising:
computer-readable program code means for programmatically generating a syntax specification which includes a plurality of alternative selectable views for at least one component;
computer-readable program code means for evaluating, at run time, one or more currently-applicable conditions; and
computer-readable program code means for using a result of the evaluation to programmatically select, from the syntax specification, a particular one of the alternative selectable views for each of the at least one components.

28. The computer program product according to claim 27, wherein the computer-readable program code means for programmatically generating further comprises computer-readable program code means for generating the syntax specification as a portion of a markup language document.
